(19) United States
(12) Patent Application Publication
(10) Pub. No.: US 2016/0153783 A1
(43) Pub. Date: Jun. 2, 2016

(54) GUIDING DEVICE

(71) Applicants: Inventec (Pudong) Technology Corporation, Shanghai (CN); INVENTEC CORPORATION, Taipei (TW)

(72) Inventor: Sheng-Hsin Lo, Taipei (TW)

(21) Appl. No.: 14/687,206

(22) Filed: Apr. 15, 2015

(30) Foreign Application Priority Data
Nov. 27, 2014 (CN) 201410710599.8

(51) Int. Cl. G01C 21/00; G01C 21/34

(52) U.S. Cl. CPC G01C 21/00; G01C 21/34

(57) ABSTRACT

The present invention provides a guiding device including a plurality of electrodes, a navigation module, and a control module. The plurality of electrodes are disposed on a surface. The navigation module is for generating an action command. The control module is electrically connected with the plurality of electrodes and is communication connected with the navigation module. The control module is for enabling part of the plurality of electrodes selectively and orderly according to the action command.

### CROSS-REFERENCE TO RELATED APPLICATIONS

This non-provisional application claims priority under 35 U.S.C. §119(a) on Patent Application No. 201410710599.8 filed in China on Nov. 27, 2014, the entire contents of which are hereby incorporated by reference.

### BACKGROUND OF THE INVENTION

1. Technical Field of the Invention

The present invention relates to a guiding device, particularly to a wearable guiding device.

2. Description of the Related Art

Referring to the outdoor assistance for the visually impaired people, it is very difficult for them to go outdoors without a guide dog or a guiding person. In addition, training a guide dog is not easy and the basic infrastructures for guiding the visually impaired people in a city are usually incomplete. Therefore, how to automatically help the visually impaired people with a device is an urgent problem.

### SUMMARY OF THE INVENTION

A guiding device illustrated in an embodiment of the present invention includes a plurality of electrodes, a navigation module, and a control module. The plurality of electrodes are disposed on a surface of the guiding device. The navigation module is for generating an action command. The control module is electrically connected with the plurality of electrodes and communication connected with the navigation module for selectively and sequentially enabling part of the plurality of electrodes according to the action command.

In an embodiment of the present invention, the action command is selected from the group consisting of a forward command, a turn-right command, a turn-left command, a stop command, a go-upstairs command and a go-downstairs command.

In an embodiment of the present invention, the navigation module includes a database, a camera unit, a positioning unit, and a path planning unit. The database is for storing a plurality of pieces of street-view data. The camera unit is for capturing a street-view image. The positioning unit is for positioning and obtaining a position. The path planning unit is for obtaining one piece of the plurality of pieces of street-view data from the database based on the position and comparing the obtained piece of street-view data with the street-view image to obtain a direction, and selecting one command from the group as the action command according to the direction and the street-view image.

In an embodiment of the present invention, the path planning unit selects one command from the group consisting of the forward command, the turn-left command, and the turn-right command as the action command according to the direction and a planned path.

In an embodiment of the present invention, when the path planning unit determines that the street-view image includes an obstacle image, the path planning unit selects the stop command from the group as the action command.

In an embodiment of the present invention, when the path planning unit determines that the street-view image includes a go-upstairs image, the path planning unit selects the go-upstairs command from the group as the action command, and when the path planning unit determines that the street-view image includes a go-downstairs image, the path planning unit selects the go-downstairs command from the group as the action command.

In an embodiment of the present invention, the navigation module determines whether the path planning unit selects the stop command, and if the path planning unit selects the stop command, the stop command is selected as the action command.

In an embodiment of the present invention, when the navigation module determines that the path planning unit does not select the stop command, the navigation module further determines whether the path planning unit selects the turn-right command, and if the path planning unit selects the turn-right command, the turn-right command is selected as the action command, and if the path planning unit does not select the turn-right command, the navigation module further determines whether the path planning unit selects the turn-left command, and if the path planning unit selects the turn-left command, the turn-left command is selected as the action command.

In an embodiment of the present invention, when the navigation module determines that the path planning unit does not select the turn-left command, the navigation module further determines whether the path planning unit selects the go-upstairs command, and if the path planning unit selects the go-upstairs command, the go-upstairs command is selected as the action command, and if the path planning unit does not select the go-upstairs command, the navigation module further determines whether the path planning unit selects the go-downstairs command, and if the path planning unit selects the go-downstairs command, the go-downstairs command is selected as the action command, and if the path planning unit does not select the go-downstairs command, the forward command is selected as the action command.

In an embodiment of the present invention, the plurality of electrodes are M*N electrodes disposed on the surface in a matrix form and M and N are integers greater than 2.

The contents of the present invention set forth and the embodiments hereinafter are for demonstrating and illustrating the spirit and principles of the present invention, and for providing further explanation of the claims.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a diagram of the guiding device according to an embodiment of the present invention;

FIG. 2 is a diagram of wearing the guiding device according to an embodiment of the present invention;

FIG. 3 is a diagram of the forward command according to an embodiment of the present invention;

FIG. 4 is a diagram of the turn-right command according to an embodiment of the present invention;

FIG. 5 is a diagram of the turn-left command according to an embodiment of the present invention;

FIG. 6 is a diagram of the stop command according to an embodiment of the present invention;

FIG. 7 is a diagram of the go-upstairs command according to an embodiment of the present invention;

FIG. 8 is a diagram of the go-downstairs command according to an embodiment of the present invention;

FIG. 9 is a functional block diagram of the navigation module according to an embodiment of the present invention;

FIG. 10 is a diagram of the planned path planned by the navigation module according to an embodiment of the present invention;

FIG. 11 is a diagram of the obstacles according to an embodiment of the present invention;

FIG. 12 is a diagram of the image of going upstairs according to an embodiment of the present invention; and

FIG. 13 is a flowchart of determining the action command by the navigation module according to an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

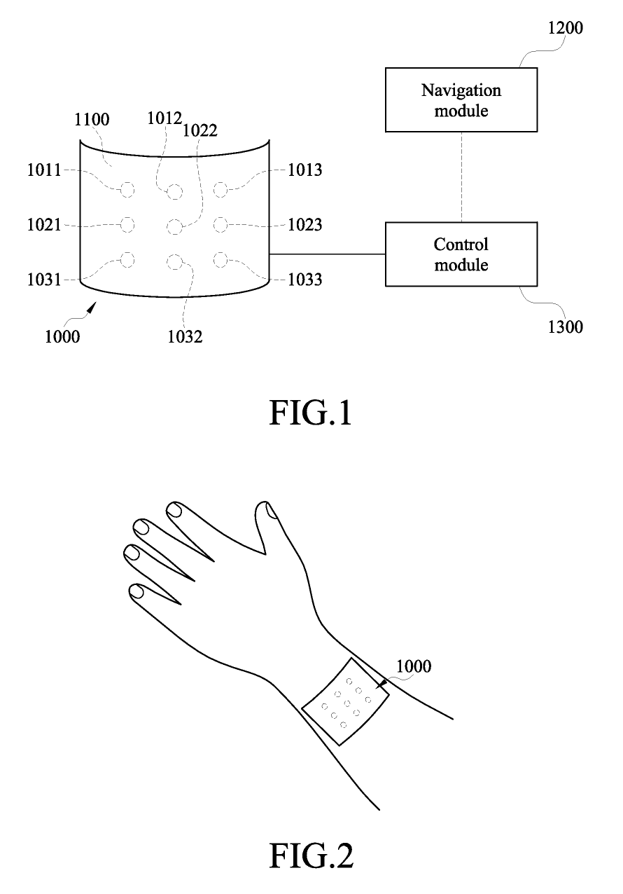

Please refer to FIG. 1. FIG. 1 is a diagram of the guiding device according to an embodiment of the present invention. As shown in FIG. 1, the guiding device 1000 includes a plurality of electrodes 1011˜1033, a navigation module 1200, and a control module 1300. The plurality of electrodes 1011˜1033 are disposed on a surface 1100 of the guiding device. The navigation module 1200 is for generating an action command. The control module 1300 is electrically connected with the plurality of electrodes 1011˜1033 and communication connected with the navigation module 1200 for selectively and sequentially enabling part of the plurality of electrodes according to the action command. The communication connection between the control module 1300 and the navigation module 1200 indicates a wired or wireless connection. In an embodiment, the structure of each electrode among the electrodes 1011˜1033 is, for example but not limited to, a convex dot or a pin. In another embodiment, the plurality of electrodes 1011˜1033 are directly attached on the skin of the user. The embodiments are for illustrating but not for limiting the present invention.

For example, please refer to FIG. 2. FIG. 2 is a diagram of wearing the guiding device according to an embodiment of the present invention. As shown in FIG. 2, the user wears the guiding device 1000 on his arm. When the navigation module 1200 generates the action command, the control module 1300 selectively and sequentially enables part of the electrodes to generate a pattern according to the action command, so that the user feels the pattern of the action command from the stimulation generated by the electrodes and takes action correspondingly. In addition, in another embodiment, the guiding device has a larger electrode surface for the user to wear the device on another limb. The embodiment is for illustrating but not for limiting the present invention.

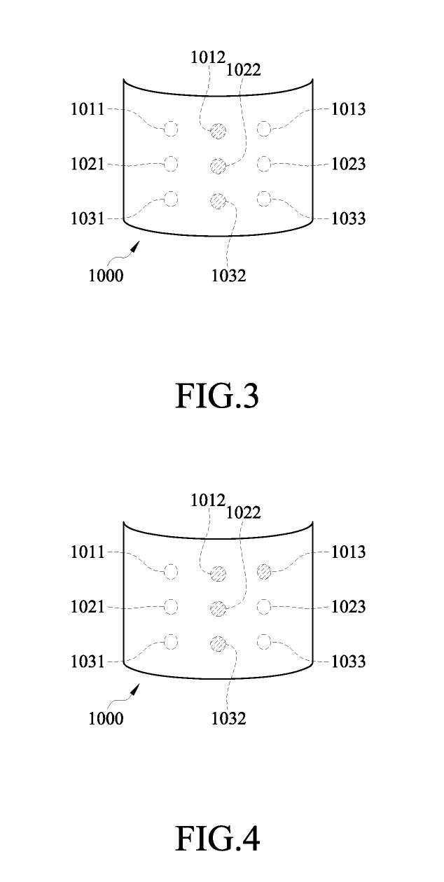

In an embodiment of the present invention, the action command is selected from the group consisting of a forward command, a turn-right command, a turn-left command, a stop command, a go-upstairs command, and a go-downstairs command. With regard to the pattern generated by selectively and sequentially enabling part of the electrodes according to the action command, please refer to FIG. 3 to FIG. 8. FIG. 3 is a diagram of the forward command according to an embodiment of the present invention. As shown in FIG. 3, when the navigation module 1200 generates a forward command, the control module 1300 firstly enables the electrode 1032, and then enables the electrode 1022, and then enables the electrode 1012 according to the pre-defined the pattern of the forward command. Therefore, when the user's skin feels the stimulation of the electrodes 1032, 1022, and 1012 sequentially, practically the user feels a forward pattern from the stimulation and knows that the navigation module 1200 guides him to move forward.

As shown in FIG. 4, when the navigation module 1200 generates a turn-right command, the control module 1300 firstly enables the electrode 1032, and then enables the electrode 1022, and then enables the electrode 1012 and the electrode 1013 simultaneously according to the pre-defined the pattern of the turn-right command. Therefore, when the user's skin feels the stimulation of the electrodes 1032, 1022, 1012, and 1013 sequentially, the user knows that the navigation module 1200 guides him to turn right.

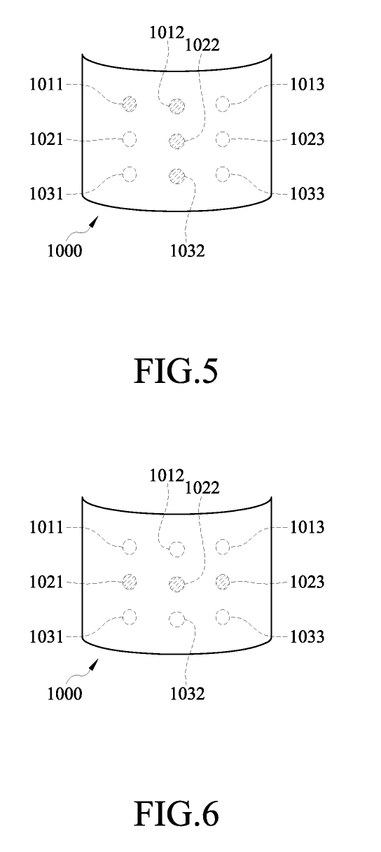

As shown in FIG. 5, when the navigation module 1200 generates a turn-left command, the control module 1300 firstly enables the electrode 1032, and then enables the electrode 1022, and then enables the electrode 1012 and the electrode 1011 simultaneously according to the pre-defined the pattern of the turn-left command. Therefore, when the user's skin feels the stimulation of the electrodes 1032, 1022, 1012, and 1011 sequentially, the user knows that the navigation module 1200 guides him to turn left.

As shown in FIG. 6, when the navigation module 1200 generates a stop command, the control module 1300 firstly enables the electrode 1021, and then enables the electrode 1022, and then enables the electrode 1023 according to the pre-defined the pattern of the stop command. Therefore, when the user's skin feels the stimulation of the electrodes 1021, 1022, and 1023 sequentially, the user knows that the navigation module 1200 guides him to stop.

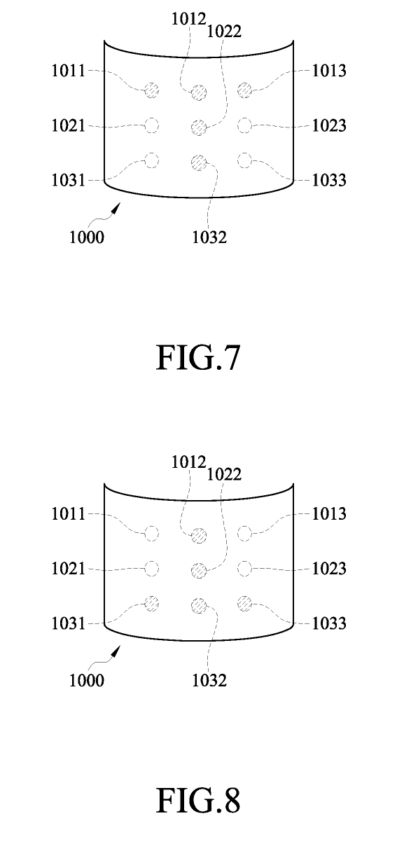

As shown in FIG. 7, when the navigation module 1200 generates a go-upstairs command, the control module 1300 firstly enables the electrode 1032, and then enables the electrode 1022, and then enables the electrodes 1011, 1012, and 1013 simultaneously according to the pre-defined pattern of the go-upstairs command. Therefore, when the user's skin feels the stimulation of the electrodes 1032, 1022, 1011, 1012, and 1013 sequentially, the user knows that the navigation module 1200 guides him to go upstairs.

As shown in FIG. 8, when the navigation module 1200 generates a go-downstairs command, the control module 1300 firstly enables the electrode 1012, and then enables the electrode 1022, and then enables the electrodes 1031, 1032, and 1033 simultaneously according to the pre-defined the pattern of the go-downstairs command. Therefore, when the user's skin feels the stimulation of the electrodes 1012, 1022, 1031, 1032, and 1033 sequentially, the user knows that the navigation module 1200 guides him to go downstairs.

The electrode patterns corresponding to the aforementioned forward command, turn-right command, turn-left command, stop command, go-upstairs command, and go-downstairs command are designed according to the size of the guiding device 1000 or the precision of the navigation module 1200. For example, the navigation module 1200 further determines the road conditions, such as a countdown timer of the traffic light when crossing the street. When the countdown seconds are less than a threshold value, the control module 1300 enables the electrodes with the pattern of the forward command and stimulates the user periodically to hurry the user to speed up. The pattern of the electrodes in the embodiment is for illustrating but not for limiting the present invention.

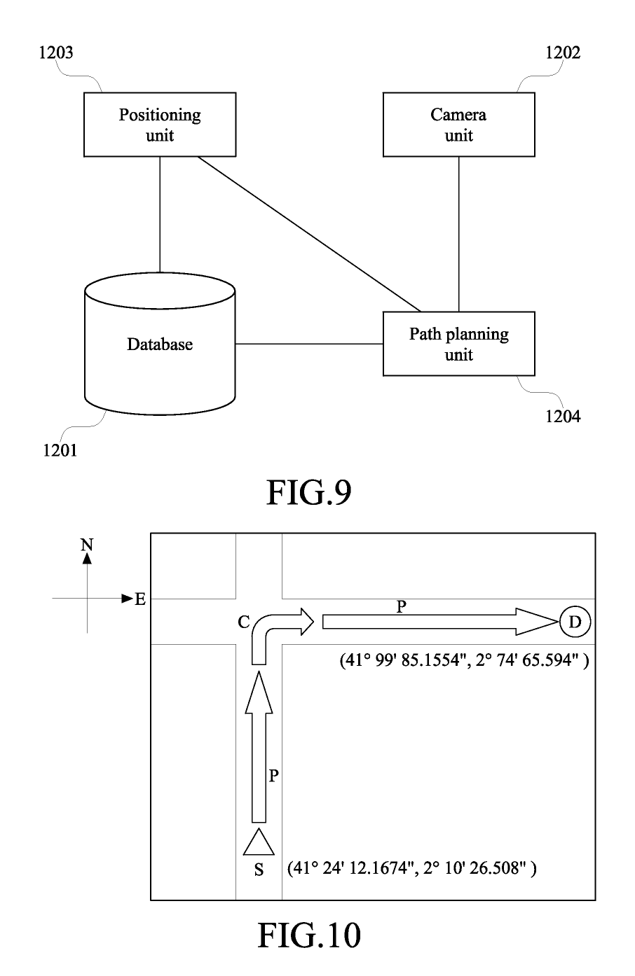

In an embodiment of the present invention, please refer to FIG. 9 for the aforementioned navigation module 1200. FIG. 9 is a functional block diagram of the navigation module according to an embodiment of the present invention. As shown in FIG. 9, the navigation module 1200 includes a database 1201, a camera unit 1202, a positioning unit 1203, and a path planning unit 1204. The database 1201 is for storing a plurality of pieces of street-view data. The camera unit 1202 is for capturing a street-view image. The positioning unit 1203 is for positioning and obtaining a position. The path planning unit 1204 is for obtaining one piece of the plurality of pieces of street-view data from the database 1201 based on the position and comparing the obtained piece of street-view data with the street-view image to obtain a direction, and selecting one command from the group as the action command according to the direction and the street-view image. In an embodiment, the navigation module 1200 is a wearable device, such as a head-mounted device, a pair of glasses. The embodiment is for illustrating but not for limiting the present invention.

For example, the database 1201 is a street-view database provided on the Internet or a self-collected street views. The camera unit 1202 is a wearable camera device, such as a mini camera installed on a pair of glasses or a helmet camera. The positioning unit 1203 is a positioning device of a smart phone. The path planning unit 1204 obtains a suitable planned path for the user by a path planning algorithm according to the collected information from the aforementioned units, and the user moves according to the planned path to reach the destination. The aforementioned units in the embodiment are for illustrating but not for limiting the present invention.

In an embodiment of the present invention, the path planning unit 1204 selects one command from the group consisting of the forward command, the turn-left command, and the turn-right command as the action command according to the direction and a planned path. For example, please refer to FIG. 10. FIG. 10 is a diagram of the planned path planned by the navigation module according to an embodiment of the present invention. As shown in FIG. 10, S is the starting point of the user, and D is the destination of the user. First, the positioning unit 1203 obtains the coordinate of the user to confirm that the current latitude and longitude coordinate is (41° 24′ 12.1674″, 2° 10′ 26.508″). Next, the camera unit 1202 is used to capture the street view to which the user currently faces. The path planning unit 1204 obtains one piece of the plurality of pieces of street-view data from the database 1201 according to the coordinate obtained by the positioning unit 1203 and further compares the obtained piece of street-view data with the street view captured by the camera unit 1202. Therefore, the path planning unit 1204 determines that the user is facing the north currently and the latitude and longitude coordinate of the destination is (41° 99′ 85.1554″, 2° 74′ 65.594″) according to the user's setting. Consequently, the path planning unit 1204 calculates a planned path P according to the aforementioned information. As shown in the figure, the planned path P firstly instructs the user to go straight to the corner C, and then instructs the user to turn right, and further instructs the user to go straight to the destination D.

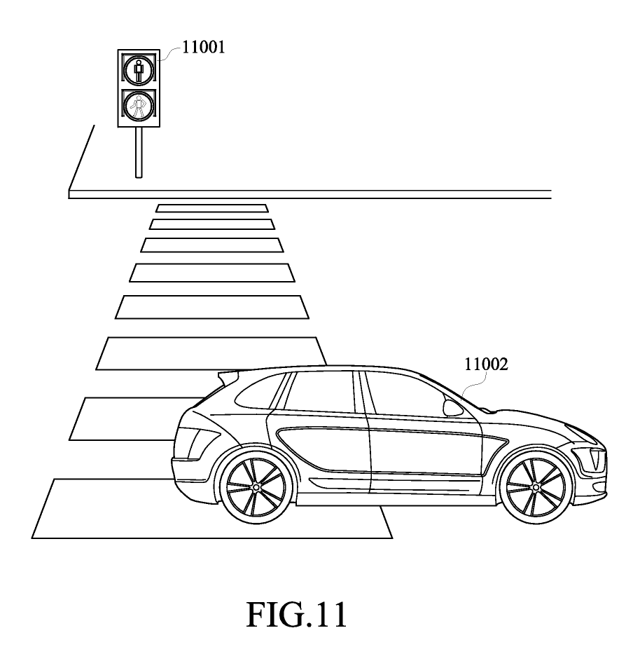

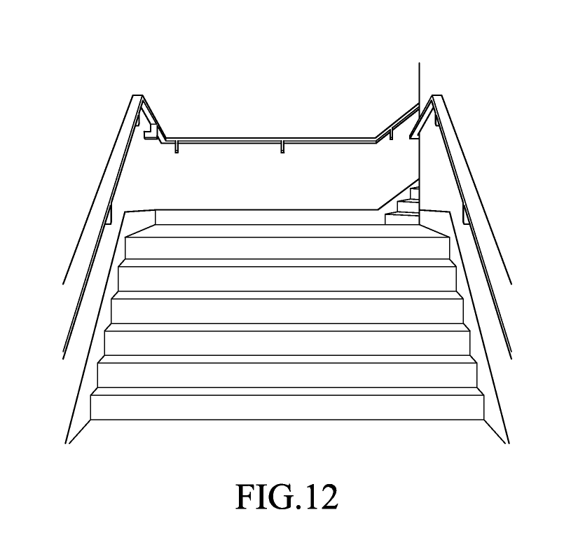

In an embodiment, when the path planning unit 1204 determines that the street-view image includes an obstacle image, the path planning unit 1204 selects the stop command from the group as the action command. For example, please refer to FIG. 11. FIG. 11 is a diagram of the obstacles according to an embodiment of the present invention. As shown in FIG. 11, after the path planning unit 1204 obtains the street-view image captured by the camera unit 1202, the path planning unit 1204 further determines the objects in the street-view image. As shown in the figure, the path planning unit 1204 determines that the image includes obstacles, such as the red light 11001 and/or the car 11002 in front of the user. At this moment, the user will encounter the danger when keeping moving forward, so the path planning unit 1204 instructs the user with the stop command.

In an embodiment of the present invention, when the path planning unit 1204 determines that the street-view image includes a go-upstairs image, the path planning unit 1204 selects the go-upstairs command from the group as the action command. When the path planning unit 1204 determines that the street-view image includes a go-downstairs image, the path planning unit 1204 selects the go-downstairs command from the group as the action command. With regard to the go-upstairs image, please refer to FIG. 12. FIG. 12 is a diagram of the image of going upstairs according to an embodiment of the present invention.

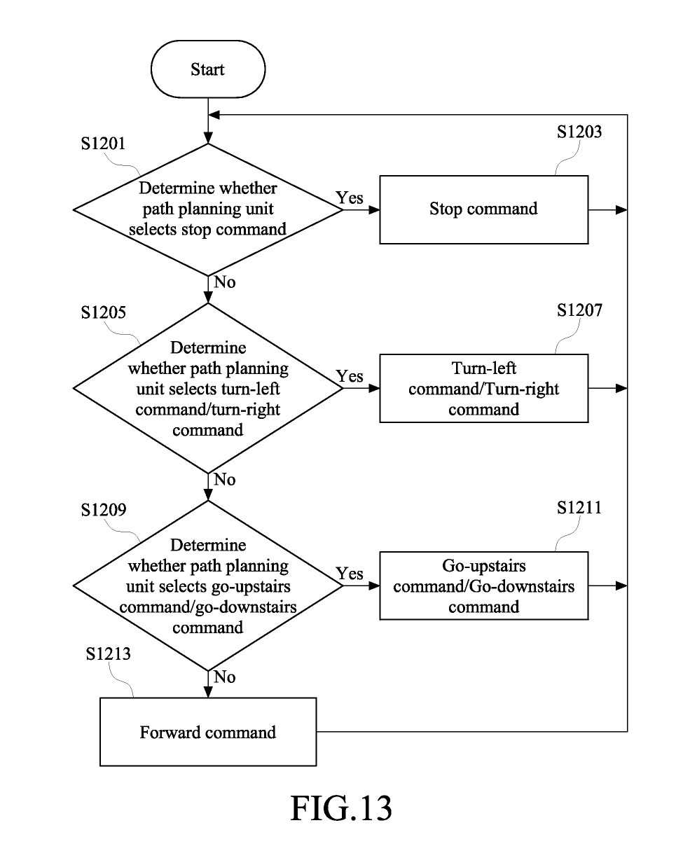

With regard to the method of determining the action command by the navigation module 1200, please refer to FIG. 13. FIG. 13 is a flowchart of determining the action command by the navigation module according to an embodiment of the present invention. As shown in FIG. 13, in the step S1201, the navigation module 1200 determines whether the path planning unit 1204 selects the stop command. If the path planning unit 1204 selects the stop command, in the step S1203, the stop command is selected as the action command. Next, when the navigation module 1200 determines that the path planning unit 1204 does not select the stop command, in the step S1205, the navigation module 1200 further determines whether the path planning unit 1204 selects the turn-right command/turn-left command. If the path planning unit 1204 selects the turn-right command/turn-left command, the turn-right command/turn-left command is selected as the action command in the step S1207. Next, when the navigation module 1200 determines that the path planning unit 1204 does not select the turn-right command/turn-left command, in the step S1209, the navigation module 1200 further determines whether the path planning unit 1204 selects the go-upstairs command/go-downstairs command. If the path planning unit 1204 selects the go-upstairs command/go-downstairs command, in the step S1211, the go-upstairs command/go-downstairs command is selected as the action command. If the path planning unit 1204 does not select the go-upstairs command/go-downstairs command, the forward command is selected as the action command in the step S1213.

In an embodiment of the present embodiment, the plurality of electrodes are M*N electrodes disposed on the surface in a matrix form and M and N are integers greater than 2. When the user needs to wear the device on another limb or the navigation module 1200 needs more different action commands, M and N are further designed according to the user's need. The embodiment is for illustrating but not for limiting the present invention.

An embodiment of the present invention provides a guiding device including a plurality of electrodes, a navigation module, and a control module. The navigation module determines the road conditions to generate an action command to the control module. The control module enables part of the plurality of electrodes to stimulate the user for indicating the action command. Therefore, the user reaches the destination safely according to the action commands and the guiding device makes the life of the visually impaired people more convenient.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A guiding device, comprising:
a plurality of electrodes disposed on a surface of the guiding device;
a navigation module for generating an action command; and
a control module electrically connected with the plurality of electrodes and communication connected with the navigation module for selectively and sequentially enabling a part of the plurality of electrodes according to the action command.

2. The device of claim 1, wherein the action command is one selected from the group consisting of a forward command, a turn-right command, a turn-left command, a stop command, a go-upstairs command and a go-downstairs command.

3. The device of claim 2, wherein the navigation module comprises:
a database for storing a plurality of pieces of street-view data;
a camera unit for capturing a street-view image;
a positioning unit for positioning and obtaining a position; and
a path planning unit for obtaining one piece of the plurality of pieces of street-view data from the database based on the position and comparing the obtained piece of street-view data with the street-view image to obtain a direction, and selecting one command from the group as the action command according to the direction and the street-view image.

4. The device of claim 3, wherein the path planning unit selects one command from the group consisting of the forward command, the turn-left command, and the turn-right command as the action command according to the direction and a planned path.

5. The device of claim 3, wherein when the path planning unit determines that the street-view image includes an obstacle image, the path planning unit selects the stop command from the group as the action command.

6. The device of claim 3, wherein when the path planning unit determines that the street-view image includes a go-upstairs image, the path planning unit selects the go-upstairs command from the group as the action command, and when the path planning unit determines that the street-view image includes a go-downstairs image, the path planning unit selects the go-downstairs command from the group as the action command.

7. The device of claim 3, wherein the navigation module determines whether the path planning unit selects the stop command, and if the path planning unit selects the stop command, the stop command is selected as the action command.

8. The device of claim 7, wherein when the navigation module determines that the path planning unit does not select the stop command, the navigation module further determines whether the path planning unit selects the turn-right command, and if the path planning unit selects the turn-right command, the turn-right command is selected as the action command, and if the path planning unit does not select the turn-right command, the navigation module further determines whether the path planning unit selects the turn-left command, and if the path planning unit selects the turn-left command, the turn-left command is selected as the action command.

9. The device of claim 8, wherein when the navigation module determines that the path planning unit does not select the turn-left command, the navigation module further determines whether the path planning unit selects the go-upstairs command, and if the path planning unit selects the go-upstairs command, the go-upstairs command is selected as the action command, and if the path planning unit does not select the go-upstairs command, the navigation module further determines whether the path planning unit selects the go-downstairs command, and if the path planning unit selects the go-downstairs command, the go-downstairs command is selected as the action command, and if the path planning unit does not select the go-downstairs command, the forward command is selected as the action command.

10. The device of claim 2, wherein the plurality of electrodes are M×N electrodes disposed on the surface in a matrix form and M and N are integers greater than 2.
